(19) United States
(12) Patent Application Publication
(10) Pub. No.: US 2009/0138390 A1
(43) Pub. Date: May 28, 2009

(54) Financial Transaction Message Exchange System

(75) Inventor: Simon Blythe, Ely (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/944,911

(22) Filed: Nov. 26, 2007

(51) Int. Cl. G06Q 20/00

(52) U.S. Cl. 705/35

(57) ABSTRACT

A system for conducting financial transactions which includes a message exchange service is disclosed. The message exchange can occur via a payment terminal and can be 1) payment device-to-payment device, 2) payment device-to-merchant, 3) merchant-to-payment device(s), 4) merchant-to-merchant, 5) anyone to/from financial institutions. The invention can enhance the paying experience, provide merchant feedback, as well as promote branding.

### FIELD OF THE INVENTION

The present invention generally relates to financial transaction systems, and more particularly to financial transaction message exchange systems.

### BACKGROUND OF THE INVENTION

Today, electronic payment systems are used to conduct financial transactions around the world. Instead of using cash, consumers are using many different types of payment devices to buy a wide range of items. These payment devices can include credit, debit, prepaid and smart cards, as well as cellular phones, personal digital assistants (PDAs), and other types of personal devices.

Payment processing networks allow consumers to use these payment devices to shop at a variety of merchants. Typically, a financial institution, such as a bank, extends credit to a consumer to purchase products or services. When a consumer makes a purchase from an approved merchant, identifying consumer information, amount of the purchase, and other relevant transactional information, are transmitted from the personal device via the processing network to a processing center which verifies the information transmitted.

One of the drawbacks of today's electronic payment systems is that they do not readily process additional information which can be related to the financial transaction. For example, consumer feedback concerning products or services purchased with payment devices is not typically captured by these systems. In addition, the payment devices are seldom used to interact with other users in a meaningful or useful way. Accordingly, there exists a need for a financial transaction system that can accommodate message exchanges.

### SUMMARY OF THE INVENTION

A system for conducting financial transactions which includes a message exchange service is disclosed. The message exchange can occur via a payment terminal and can be 1) payment device-to-payment device, 2) payment device-to-merchant, 3) merchant-to-payment device(s), 4) merchant-to-merchant, 5) anyone to/from financial institutions. The invention can enhance the paying experience, provide merchant feedback, as well as promote branding.

Various aspects of the system relate to sending and receiving messages and conducting financial transactions. For example, according to one aspect, a system for conducting a financial transaction includes a payment device capable of sending (i) a message in response to at least one of user keyed activation and detection of a network and (ii) a financial transaction instruction. The system also includes a payment terminal capable of receiving the message and conducting the financial transaction instruction over a conventional payment network. Preferably, the message includes either product or service related information.

In one preferred embodiment, the network is at least one of a wireless network and a wired network. The system can also include a display operatively coupled to the payment terminal for displaying the message. The message can include digital media.

In one preferred embodiment, the payment device is capable of receiving at least one of a wireless message and wired message from either the payment terminal or another payment device. Preferably, the payment device or payment terminal associates the wireless message with the financial instruction.

In one preferred embodiment, the payment device includes a database for storing the message. The message preferably includes a description of the financial transaction.

In one preferred embodiment, the payment device is selected from the group consisting essentially of a smart card, PDA, cellular phone, and the like.

In another preferred embodiment, the message is downloaded into a memory of the payment device.

In yet another aspect, a method for conducting a financial transaction includes providing a payment device capable of sending (i) a message in response to at least one of user keyed activation and detection of a network and (ii) a financial transaction instruction. The method also includes providing a payment terminal capable of receiving the message and processing the transaction instruction.

In one preferred embodiment, the method further includes associating the message with the financial transaction. The method can also include charging a fee for receiving the message. In another preferred embodiment, the method includes charging a fee for receiving the message based on a length of the message.

In another preferred embodiment, the method includes displaying the message on a display device operatively coupled to the payment device.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a financial transaction system according to the present invention.

FIG. 2 is a flow chart of a method for providing a financial transaction message exchange.

Like reference symbols in the various drawings indicate like elements.

### DETAILED DESCRIPTION OF THE PREFERRED EMBODIMENTS

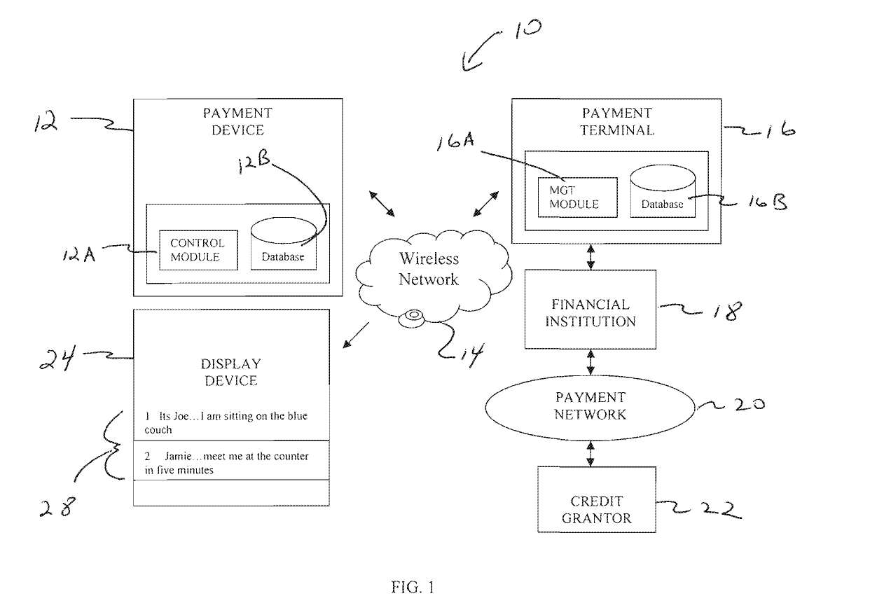

FIG. 1 shows a financial transaction message exchange system 10 according to the present invention. The system 10 can be used to conduct financial transactions and to exchange messages between users, merchants, and financial institutions. Preferably, the message exchange occurs via a payment terminal and can be 1) payment device-to-payment device, 2) payment device-to-merchant, 3) merchant-to-payment device(s), 4) merchant-to-merchant, 5) anyone to/from financial institutions. The invention can enhance the paying experience, provide merchant feedback, as well as promote branding.

In one preferred embodiment, as shown in FIG. 1, the system 10 includes a payment device 12 capable of receiving and sending financial transaction information and messages, a payment terminal 16 that may operate as a point of sale (POS) terminal for merchants, and a wireless network 14 for operatively connecting the payment device 12 to the payment terminal 16.

The payment device 12 shown in FIG. 1 can be any type of personal computer device, including but not limited to personal computers, such as laptop computers, handheld computers, mobile phones, personal digital assistants, media centers/players, music recorders/players, and/or any other device comprising electronic components, such as a smart card. Although only one payment device is shown in FIG. 1, the present invention is not limited to one payment device and can include a multitude of varied payment devices that are capable of communicating using a wireless protocol.

In one preferred embodiment, the payment device 12 is a mobile phone that includes a central processor unit (CPU), random access memory (RAM), an input-output control module, and non-volatile memory, all of which are interconnected via a bus line and controlled by the CPU. Preferably, the non-volatile memory of the device 12 is configured to include a control module 12A for communicating financial transaction instructions and messages, and a device database 12B that operates to store payment device messages and financial transaction instructions for transmission over the network 14.

Preferably, the payment device 12 includes a display screen (not shown) that can be used to display messages received from other users, merchants and financial institutions via the payment terminal 16. The payment device 12 also can include data entry keys (not shown) for entering user-defined messages for transmission. For example, the user-defined message information can relate to products or services purchased and/or payment amounts. The device 12 also includes a transmission key (not shown) for communicating user-defined messages and financial transaction instructions to the payment terminal 16. Preferably, the display screen, data entry keys, and transmission key operate under the control of the input-output module.

The device database 12B provides storage for one or more financial transaction instructions and user-defined messages. In one preferred embodiment, the control module 12A of the device allows a user to enter a message and message type which the control model 12A then associates with a financial transaction instruction in the database 12B. Both the financial transaction instruction and associated user-defined messages can be subsequently communicated to a merchant through the payment terminal 16.

For example, using the present invention, the payment device 12 can provide consumer product and/or service related information, such as feedback, inventory requests, and the like, with financial transaction instructions at the point of sale. It will be appreciated by one skilled in the art, however, that the present invention is not limited to associating user-defined messages with financial transaction instructions. For example, as shown in FIG. 1 and described below, user-defined messages 28 separate from financial transaction instructions can be processed by the system.

Preferably, the device database 12B includes strong cryptography to secure user identity information, such as account numbers and banking information. In one preferred embodiment, the device database 12B is a configured area in memory of the payment device 12. In another preferred embodiment, the device database 12B is a portable database that is downloaded to the device 12.

In one preferred embodiment, the payment terminal 16 of the present invention is a computer device that operates as a point of sale terminal for goods or services rendered. As shown in FIG. 1, in one preferred embodiment, the payment terminal 16 includes a management module 16A for processing financial transaction instructions and user-defined messages and a terminal database 16B for storing financial transaction activity and user-defined messages.

As shown in FIG. 1, the payment terminal 16 is preferably in communication with a financial institution 18, such as a bank, which has access to a conventional payment network 20 in which the merchant has a financial account. A credit grantor 22 is also preferably in communication with the payment network 20 and provides a particular level of credit to the payment device user.

In one preferred embodiment, as shown in FIG. 1, the network 14 is a wireless network that can be an 802.11-compliant network, Bluetooth network, cellular digital packet data (CDPD) network, high speed circuit switched data (HSCSD) network, packet data cellular (PDC-P) network, general packet radio service (GPRS) network, 1× radio transmission technology (1×RTT) network, IrDA network, multichannel multipoint distribution service (MMDS) network, local multipoint distribution service (LMDS) network, worldwide interoperability for microwave access (WiMAX) network, and/or any other network that communicates using a wireless protocol.

In another preferred embodiment, the network 14 is a wired network that can include Ethernet, phone line networks, as well as power line networks.

As shown in FIG. 1, in one preferred embodiment, the system 10 includes a display device 24 that is used by the management module 16A of the payment terminal 16 to display various types of user-defined messages 28. Preferably, the display device 24 is operably connected to the payment terminal via the network 14 using a wireless protocol. For example, in one preferred embodiment, the display device 24 operates as an electronic moving message board that allows the management module 16A to post received user-defined messages 28. The user-defined messages 28 can be text-based messages that include digital media including images.

Preferably, the display device 24 is positioned at or near the payment terminal 16 or alternatively in an area generally accessible for viewing by system users. For example, in one preferred embodiment, the display device 24 is positioned in a window of the merchant's establishment. In another preferred embodiment, the display device 24 is positioned outside the merchant's establishment. In yet another preferred embodiment, the display device is positioned in juxtaposition to the payment terminal 16.

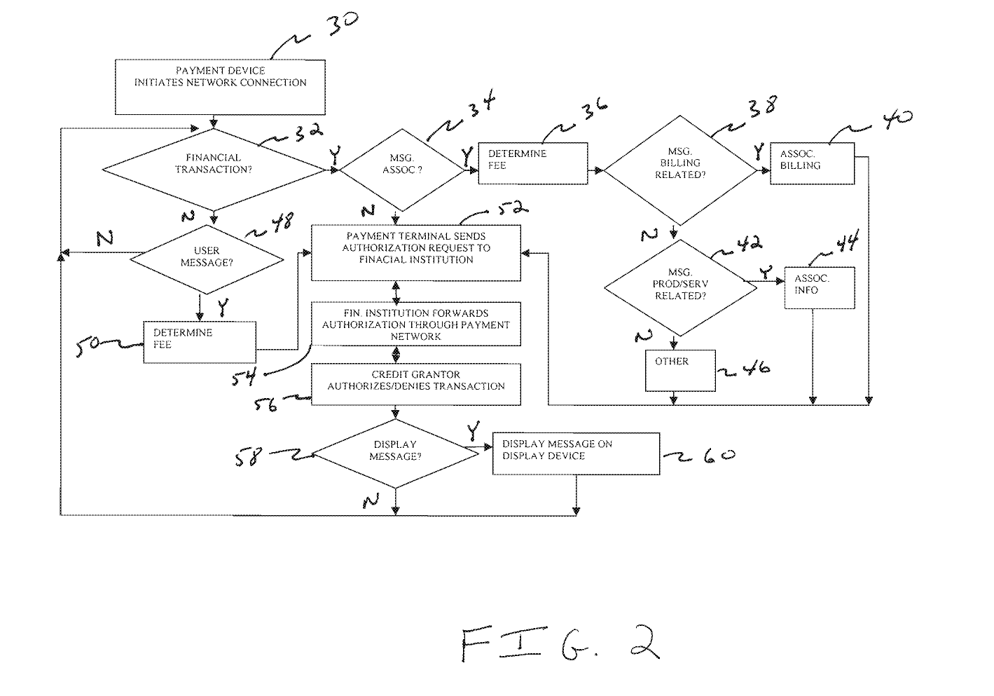

Referring now to FIG. 2, a method for providing a financial transaction message exchange system is shown. As shown in the FIG. 2 example, first, the control module 12A of the payment device 12 initiates a network connection 30 through the payment terminal 16. In one preferred embodiment, the device 12 initiates the connection by polling for a wireless network connection as is known in the art. In another preferred embodiment, the device 12 is physically attached to the network 14 via a wired connection. Preferably, the network connection is a secure connection that includes encryption and digital authentication. Upon the payment terminal 16 verifying the authenticity of the payment device 12, the payment terminal 16 grants network access to the payment device 12.

Once the payment device 12 is connected to the network 14, the user of the payment device 12 may send financial transactions and/or messages through the system. For example, in one preferred embodiment, when the user of the payment device 12 desires to purchase goods or services from a merchant, the payment device 12 communicates a financial transaction instruction to the payment terminal 32.

For example, in one wireless embodiment, the payment device 12 includes one or more radio frequency identification (RFID) chips that allow the device user to store credit card and bank account numbers in the payment device database 12B. Upon swiping the payment device 12 across a sensor of the payment terminal 16, a financial transaction instruction to charge a particular account and any associated user-defined messages are communicated to the payment terminal 16.

Once a transmission from the payment device 12 to the payment terminal 16 occurs, the management module 16A of the payment terminal 16 determines if the transmission includes a financial transaction instruction 32. If so, the management module 16A next determines if an associated message for the transaction instruction was included in the received transmission 34. In one preferred embodiment, if an associated message is included in the received transmission, the management module 16A calculates a fee to be charged for processing the associated message.

For example, in one preferred embodiment, the management module 16A determines a flat fee for processing the associated message. In another preferred embodiment, the management module 16 determines a fee based on the size of the associated message. In yet another preferred embodiment, the management module 16A determines a fee based on the type of message being requested. For example, in one preferred embodiment, as discussed below, one message type may relate to goods or services rendered, another message type can relate to billing, and another message type can be a display request.

As shown in FIG. 2, if the message type is related to invoicing or billing 38, the management module may set a particular fee for copying the associated message to available fields in the financial transaction instruction 40 and providing the modified financial transaction instruction to the credit grantor 22 through the payment network 20. An example of this may be setting a tag to identify a particular purchase, such as “MY FAVORITE RESTAURANT” which could appear on the user's invoice or account bill and aid in clearer statement analysis.

If the message type is related to product or services 42, the management module 16A may create a record of the message for subsequent review by the merchant 44. For example, if the associated message concerns consumer feedback regards goods or services rendered, or special requests from consumers for particular goods or services, the management module 16A stores this information in the payment terminal database 16B for subsequent review by the merchant. Otherwise, if the message type is not related to product or services or billing, the management module 16A stores the associated message for subsequent review by the merchant 46.

If the transmission from the payment device 12 to the payment terminal 16 does not include a financial transaction instruction, the management module 16A of the payment terminal 16 determines if the transmission includes a user-defined message 48.

For example, a user of the payment device 12 may enter a user-defined message on the device to indicate their present location, which could be broadcast on the network by the management module 16A to other device users, displayed by the management module 16A on the display device 24, or a combination thereof. As described previously, in some preferred embodiments, the user-defined messages can include digital medial which the management module 16A can display on the display device 24.

As shown in FIG. 2, if the transmission includes a user-defined message, in one preferred embodiment, the management module 16A determines a fee 50 for the message as similarly described. In another preferred embodiment, the management module 16A does not calculate a fee.

Advantageously, users of the system 10 can be made aware of the location of each other as well as other descriptive information using the system 10. Accordingly, the present invention allows messages to be communicated that can link users of particular merchant at a location.

Once the management module 16A determines whether the transmission includes a financial transaction instruction and associated message or only a user-defined message, and calculates any fees if applicable, the management module 16A sends an authorization request to the financial institution 52. The financial institution 18 then forwards the authorization request through the payment network 54.

The financial institution 18 in turn forwards the authorization request 54 through the payment network 20 to the credit grantor 22. Based upon the payment device user's account status and the amount of transaction, the credit grantor 22 authorizes or denies the authorization request 56. The grantor's 22 response is routed through the payment network 20 and the financial institution 18 to the payment terminal 16 and payment device 12. As shown in FIG. 2, in one preferred embodiment, if the message type is to be displayed on the display device 58, the management module 16A communicates the message to the display device for display 58.

A number of embodiments of the invention have been described. Nevertheless, it will be understood that various modifications may be made without departing from the spirit and scope of the invention. For example, payment terminals can provide messages to payment devices that could include information relating to upcoming offers and sales. Also, the steps described above may be modified in various ways or performed in a different order than described above, where appropriate. Accordingly, alternative embodiments are within the scope of the following claims.

1. A system for conducting a financial transaction comprising:
a payment device capable of sending (i) a wireless message in response to at least one of user keyed activation and detection of a wireless network and (ii) a financial transaction instruction, the wireless message including user provided feedback associated with goods purchased or services rendered; and
a payment terminal capable of receiving said wireless message and conducting said financial transaction instruction over a conventional payment network, the payment terminal including a management module to determine if the financial transaction instruction includes a wireless message, and a payment terminal database for storing the financial transaction instruction and wireless message, the management module generating a record of the financial transaction instruction and wireless message in response to the wireless message being related to products or services, the management module storing the record in the payment terminal database in response to the wireless message being related to products or services.

2. The system of claim 1, wherein the network is at least one of a wireless network and wired network.

3. The system of claim 1, wherein said message comprises product or service related information.

4. The system of claim 1, further comprising a display operatively coupled to said payment terminal for displaying said message.

5. The system of claim 4, wherein said message comprises digital media.

6. The system of claim 1, wherein said payment device is capable of receiving at least one of a wireless message and wired message from at least one of said payment terminal and a second payment device.

7. The system of claim 1, wherein at least one of said payment device and said payment terminal associates said message with said financial instruction.

8. The system of claim 1, wherein said payment device comprises a database for storing said message.

9. The system of claim 1, wherein said message comprises a description of said financial transaction.

10. The system of claim 1, wherein said payment device is selected from the group consisting essentially of a smart card, PDA, and cellular phone.

11. The system of claim 1, wherein said message is downloaded into a memory of the payment device.

12. A method for conducting a financial transaction comprising:
providing a payment device capable of sending (i) a message in response to at least one of user keyed activation and detection of a network and (ii) a financial transaction instruction, the wireless message including user provided feedback associated with goods purchased or services rendered; and
a payment terminal capable of receiving said wireless message and conducting said financial transaction instruction over a conventional payment network, the payment terminal including a management module to determine if the financial transaction instruction includes a wireless message, and a payment terminal database for storing the financial transaction instruction and wireless message, the management module generating a record of the financial transaction instruction and wireless message in response to the wireless message being related to products or services, the management module storing the record in the payment terminal database in response to the wireless message being related to products or services.

13. The method of claim 12, further comprising associating said message with said financial transaction.

14. The method of claim 12, further comprising charging a fee for receiving said message.

15. The method of claim 12, further comprising charging a fee for receiving said message based on a length of said message.

16. The method of claim 12, further comprising displaying said message on a display device operatively coupled to said payment device.

17. The system of claim 1, wherein said message includes a user location.

18. The system of claim 1, wherein said message includes user provided feedback.

19. The system of claim 1, wherein said message includes user provided merchant identification.

20. The method of claim 12, wherein said message includes a user location.

21. The method of claim 12, wherein said message includes user provided information.

22. The method of claim 12, wherein said message includes user provided merchant identification.
